(19) United States
(12) Patent Application Publication
(10) Pub. No.: US 2009/0074075 A1
(43) Pub. Date: Mar. 19, 2009

(54) EFFICIENT REAL-TIME RATE CONTROL FOR VIDEO COMPRESSION PROCESSES

(75) Inventors: Oscar Chi Lim Au, Hong Kong (CN); Dicky Chi Wah Wong, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/855,841

(22) Filed: Sep. 14, 2007

(51) Int. Cl. H04N 7/12

(52) U.S. Cl. 375/240.22

(57) ABSTRACT

In advanced video coding standards such as H.264, macro-blocks belong to more advanced MB types, such as skipped and non-skipped macro-blocks. In non-skipped macro-blocks, the encoder determines whether each of 8×8 luminance sub-blocks and 4×4 chrominance sub-block of a macro-block is to be encoded, giving the different number of sub-blocks at each macro-block encoding times. It has been found that the correlation of bits between consecutive frames is high. This correlation is even higher after macro-block normalization by considering advanced macro-block types. Based on this bit characteristic, a fast real-time H.264 rate control scheme is herein described. The empirical example results suggest that this scheme can achieve PSNR gain over JM10.2.

### TECHNICAL FIELD

The subject disclosure relates to rate control optimizations for video encoding processes that efficiently process video data according to a processing model.

### BACKGROUND

H.264 is a commonly used and widely adopted international video coding or compression standard, also known as Advanced Video Coding (AVC) or Moving Pictures Experts Group (MPEG)-4, Part 10. H.264/AVC significantly improves compression efficiency compared to previous standards, such as H.263+ and MPEG-4. To achieve such a high coding efficiency, H.264 is equipped with a set of tools that enhance prediction of content at the cost of additional computational complexity. In H.264, macro-blocks are used wherein macro-block (MB) is a term used in video compression, which represents a block of 16 by 16 pixels. In the YUV color space model, each macro-block contains 4 8×8 luminance sub-blocks (or Y blocks), 1 U block, and 1 V block (4:2:0, wherein the U and V provide color information). It also could be represented by 4:2:2 or 4:4:4 YCbCr format (Cb and Cr are the blue and red Chrominance components).

Most video systems, such as H.261/3/4 and MPEG-1/2/4, exploit the spatial, temporal, and statistical redundancies in the source video. Some macro-blocks belong to more advanced macro-block types, such as skipped and non-skipped macro-blocks. In non-skipped macro-blocks, the encoder determines whether each of 8×8 luminance sub-blocks and 4×4 chrominance sub-block of a macro-block is to be encoded, giving the different number of encoded sub-blocks at each macro-block encoding times. It has been found that the correlation of bits between consecutive frames is high. Since the level of redundancy changes from frame to frame, the number of bits per frame is variable, even if the same quantization parameters are used for all frames.

Therefore, a buffer is typically employed to smooth out the variable video output rate and provide a constant video output rate. Rate control is used to prevent the buffer from over-flowing (resulting in frame skipping) or/and under-flowing (resulting in low channel utilization) in order to achieve good video quality. For real-time video communication such as video conferencing, proper rate control is more challenging as the rate control is employed to satisfy the low-delay constraints, especially in low bit rate channels.

Some conventional rate control schemes calculate quantization parameters of MBs based on the current MB residue information such as standard deviation and the sum of absolute differences (SAD). However, the complexity of the calculation for such MB residue information is high and this calculation is a one factor affecting the overall complexity of the rate control scheme.

The above-described deficiencies of current designs for H.264/AVC—assisted encoding or compression are merely intended to provide an overview of some of the problems of today's designs, and are not intended to be exhaustive. Other problems with the state of the art and corresponding benefits of the innovation may become further apparent upon review of the following description of various non-limiting embodiments of the innovation.

### SUMMARY

Video data processing optimizations are provided for video encoding and compression processes that efficiently encode data. The optimizations take into account dependencies introduced by having a variable number of bits per frame while providing a constant video output rate. A buffer is employed to smooth out the variable video output rate and provide a constant video output rate. Rate control is used to prevent the buffer from over-flowing (resulting in frame skipping) or/and under-flowing (resulting in low channel utilization) in order to achieve good video quality.

In advanced video coding standards such as H.264, macro-blocks belong to more advanced MB types, such as skipped and non-skipped macro-blocks. In non-skipped macro-blocks, the encoder determines whether each of 8×8 luminance sub-blocks and 4×4 chrominance sub-block of a macro-block is to be encoded, giving the different number of sub-blocks at each macro-block encoding times. It has been found that the correlation of bits between consecutive frames is high. This correlation is even higher after macro-block normalization by considering advanced macro-block types. Based on this bit characteristic, a fast real-time H.264 rate control scheme is herein described. The empirical example results suggest that this scheme can achieve a peak signal to noise ration (PSNR) gain over conventional systems. The herein described methods and apparatus facilitate receiving at least one reference frame of the sequence of image frames, identifying a set of macro-blocks within a current frame of the sequence to be encoded, normalizing the macro-blocks based on a Y/UV sampling ratio where U and V provide color information and Y refers to luminance, and storing the normalized macro-blocks in a computer readable storage medium.

A simplified summary is provided herein to help enable a basic or general understanding of various aspects of exemplary, non-limiting embodiments that follow in the more detailed description and the accompanying drawings. This summary is not intended, however, as an extensive or exhaustive overview. The sole purpose of this summary is to present some concepts related to the various exemplary non-limiting embodiments of the innovation in a simplified form as a prelude to the more detailed description that follows.

### BRIEF DESCRIPTION OF THE DRAWINGS

The rate control optimizations for video encoding processes in accordance with the innovation are further described with reference to the accompanying drawings in which:

FIG. 1 illustrates exemplary, non-limiting encoding processes performed in accordance with the rate control optimizations for video encoding processes in accordance with the innovation;

FIG. 2 illustrates exemplary, non-limiting decoding processes performed in accordance with the rate control optimizations for video encoding processes in accordance with the innovation;

FIG. 3 is a flow diagram illustrating exemplary flow of data between a host and graphics subsystem in accordance with the rate control optimizations for video encoding processes in accordance with the innovation;

FIG. 4 is a flow diagram illustrating exemplary flow to encode a macro-block in accordance with the rate control optimizations for video encoding processes in accordance with the innovation.

FIG. 5 is a flow diagram illustrating exemplary flow to estimate bits in accordance with optimizations for video encoding processes in accordance with the innovation;

FIG. 6 is a flow diagram illustrating exemplary flow to encode macro-blocks in accordance with optimizations for video encoding processes in accordance with the innovation;

FIG. 7 illustrates the results achieved in an implementation in accordance with optimizations for video encoding processes in accordance with the innovation;

FIG. 8 is another flow diagram illustrating exemplary aspects of a process for performing optimized frame layer control rate for video encoding in accordance with the innovation;

FIG. 9 is a block diagram representing an exemplary non-limiting computing system or operating environment in which the present innovation may be implemented; and

FIG. 10 illustrates an overview of a network environment suitable for service by embodiments of the innovation.

### DETAILED DESCRIPTION

### Overview

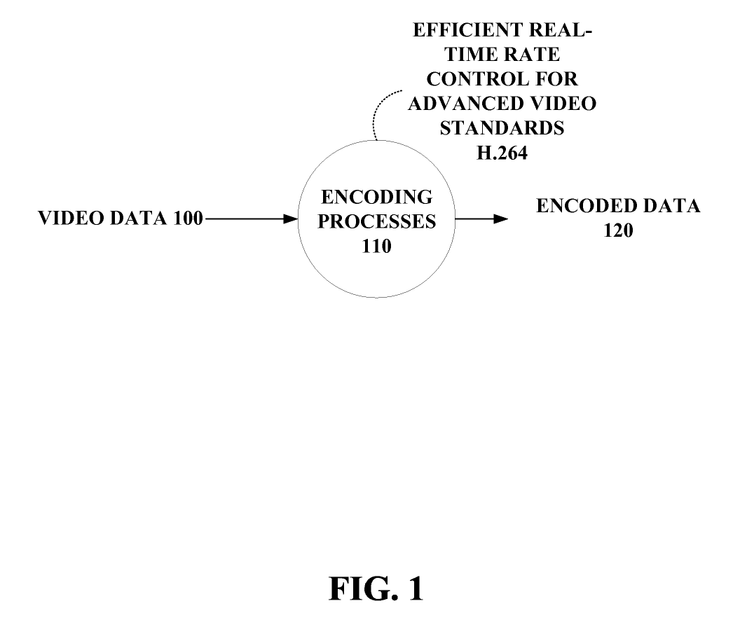

As discussed in the background, current systems calculate quantization parameters of macro-blocks (MB) based on the current MB residue information such as standard deviation and the sum of absolute differences (SAD). However, the complexity of the calculation for such MB residue information is high and this calculation is a major factor of affecting the overall complexity of the rate control scheme. This problem is addressed by various aspects of the invention by designing a processing model that optimizes calculating quantization parameters by dynamically varying the quantization parameter (QP). As shown in FIG. 1, at a high level, video encoding includes receiving video data 100, encoding the video data 100 according to a set of encoding rules implemented by a set of encoding processes 110 that enable a corresponding decoder (not shown in FIG. 1) to decode the encoded data 120 that results from encoding processes 110. Encoding processes 110 typically compress video data 100 such that representation 120 is more compact than representation 100. Encodings can introduce loss of resolution of the data while others are lossless allowing video data 100 to be restored to an identical copy of video data 100.

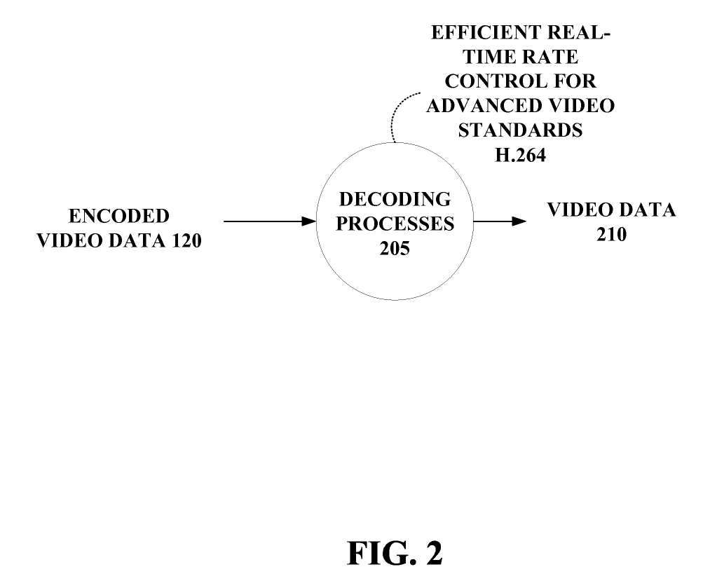

As shown by FIG. 1, an example of an encoding format is H.264/AVC. To encode data in H.264/AVC format, video data 100 is processed by encoding processes 110 that implement H.264/AVC encoding processes, which results in encoded data 120 encoded according to the H.264/AVC format. As shown by FIG. 2, an example of a decoding format is also H.264/AVC. To decode data in H.264/AVC format, encoded video data 120 is processed by decoding processes 205 that implement H.264/AVC decoding processes, which results in video data 210 that is displayed to a user or users. The video data may have sustained some loss due to the compression.

As mentioned above, however, optimized quantization parameters would be desirable. Accordingly, to address these deficiencies, as generally illustrated in the block diagram of FIG. 1, the innovation performs efficient real-time rate control for advanced video standards, such as H.264/AVC, that introduce block level dependencies. As a result of using the optimal encoding processes of the innovation, in an H.264/AVC encoding environment the peak signal-to-noise ratio, often abbreviated as PSNR, is increased over conventional standards, such as the JM10.2 standard. PSNR is an engineering term for the ratio between the maximum possible power of a signal and the power of corrupting noise that affects the fidelity of its representation. Because many signals have a very wide dynamic range, PSNR is usually expressed in terms of the logarithmic decibel. Table 5 below illustrates the gains. Typical values for the PSNR in image compression are between 30 and 40 dB.

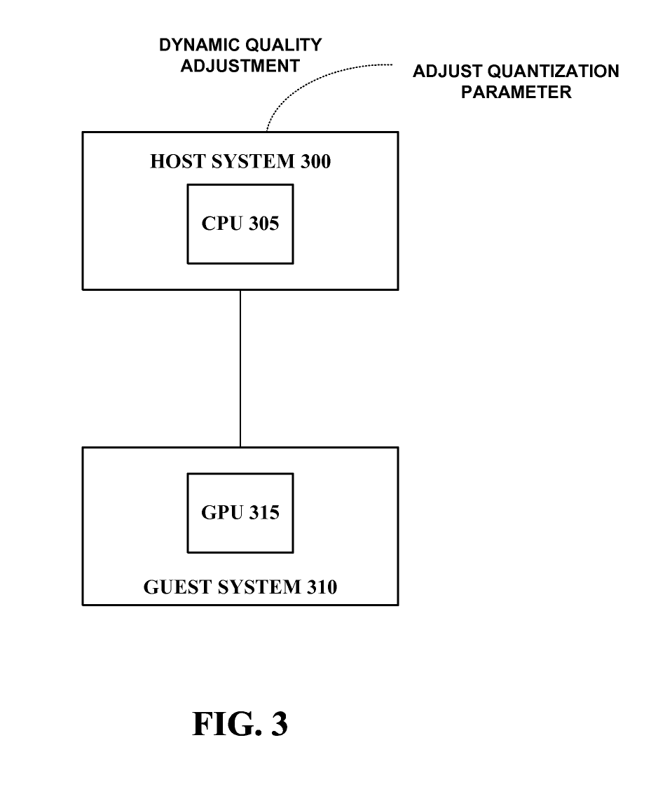

FIG. 3 is a block diagram illustrating an exemplary, non-limiting processing model for dynamic quality adjustment for performing the optimized encoding in accordance with one embodiment. A host system 300 performs the encoding processing on a host processor, such as CPU 305 of host system 300. Many computers include a graphics card and the data is ultimately sent to the graphics card. Also the host computer 300 can be connected to a guest system 310 with a guest processing unit (GPU) 315. Guest system 310 can be a graphics card or a computer. As explained in greater detail below the first frame is intra-coded (I-frame) with a fixed quantization parameter and all subsequent frames are encoded as P-frames. This means that they are predicted from the corresponding previous decoded frames using motion compensation and the residue is obtained. First, the rate control is done in the frame layer, then the rate control is done in the macro-block level. These encoded frames are then transmitted to guest system 310. As a result of using the optimal encoding processes of the innovation, in an H.264/AVC encoding environment the PSNR is increased over the JM10.2 standard.

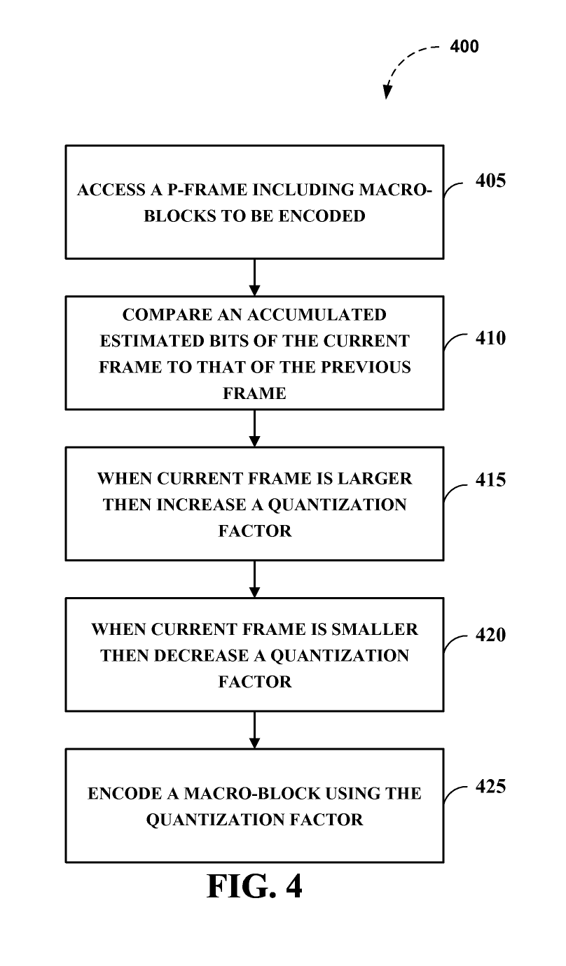

FIG. 4 is a flow diagram of a generalized process 400 for performing optimal encoding in accordance with the innovation. At 405, a P-frame of a sequence of video is accessed. The P-frame includes macro-blocks. At 410, a comparison of an accumulated estimated bits of the current frame to the previous frame is done. Next, at 410, when the current frame is larger than the prior frame the quantization parameter is increased. At 420 when the current frame is smaller than the previous frame the quantization factor is decreased. At 425 the macro-block is encoded using the quantization factor (parameter).

As a roadmap for what follows, a brief overview of some macro-block characteristic in H.264 is described such as energy, and then a bit correlation between consecutive frames is described. A normalization method is described in order to achieve even greater bit correlation. Scene change is described as well as rate control for both the frame layer and the macro-block layer.

### Energy Determination and Encoding

In H.264, frames are divided into Nmacro-blocks of 16×16 luminance samples each, with two corresponding 8×8 chrominance samples. In QCIF picture format, there are 99 macro-blocks for each frame. Quarter Common Intermediate Format (QCIF) is a format used mainly in desk top and videophone applications, and has one fourth of the area as quarter implies of the Common Intermediate Format (CIF). The CIF is used to standardize the horizontal and vertical resolutions in pixels of YCbCr sequences in video signals. CIF was designed to be easy to convert to PAL or NTSC standards. CIF was first proposed in the H.261 standard. CIF defines a video sequence with a resolution of 352×288, a framerate of 30000/1001 (roughly 29.97) fps, with color encoded using YCbCr 4:2:0. A number of consecutive macro-blocks in raster-scan order can be grouped into slices, representing independent coding units to be decoded without referencing other slices of the same frame.

Given that the whole frame is adopted as a unit slice, the frame header is encoded and N macro-blocks are processed one by one. The resulting macro-block syntax is macro-block header followed by macro-block residue data. In a P-frame, the macro-block header basically consists of run-length, macro-block mode, motion vector data, coded block pattern (CBP) and change of quantization parameter. When the macro-block header starts to be encoded, the run-length indicates the number of skipped macro-blocks that are made by copying the co-located picture information from the last decoded frame. Table 1 shows the relative percentage of the number of skipped macro-blocks (MBₛ) and non-skipped macro-blocks (MB_{N}) in H.264. The empirical example conditions are described as follows. The picture format is QCIF, the encoded frame rate is 10 fps, the structure of groups of pictures (GOP) is IPPP (an initial I-frame followed by a plurality of P-frames), maximum search range is 16, the number of reference frame is 1 and the entropy coding method is UVLC. The universal variable length code (UVLC) is a new scheme to encode syntax elements and has some configurable capabilities. It is also being considered in ITU-T H.26L. However, the configurable feature of the UVLC has not been well explored.

TABLE 1
Relative percentage of the number of skipped macro-blocks and
non-skipped macro-blocks in H.264.

| Video | | | |
|---|---|---|---|
| Sequence | QP | MBₛ (%) | MB_{N} (%) |
| Akiyo | 15 | 43.4 | 56.6 |
| | 35 | 85.3 | 14.7 |
| | 45 | 95.9 | 4.1 |
| Foreman | 15 | 0.1 | 99.9 |
| | 35 | 30.8 | 69.2 |
| | 45 | 61.0 | 39.0 |
| Stefan | 15 | 0.2 | 99.8 |
| | 35 | 17.8 | 82.2 |
| | 45 | 47.2 | 52.8 |

It is observed that for any video sequences, the percentage of skipped macro-blocks increases with QP as skipped macro-blocks can save more bits with reasonable video quality. It is also noticed that fast-motion video sequence such as “Stefan” requires more non-skipped macro-blocks compared with other sequences at any given QP because the use of dominant skipped macro-blocks cannot give reasonable video quality in fast-motion sequences.

In the macro-block header, the CBP determines the number of Y/UV sub-blocks and their encoded bits. Four bits of 6-bit CBP (called CBPY see e.g., T. Wiegand, “Working Draft Number 2, Revision 8(WD-2 rev 8)”, JVT-B118r8, ISO/IEC MPEG & ITU-T-T VCEG, Geneva, Switzerland, 29 Jan.-29 Feb. 2002) indicates whether each of 4 8×8 luminance (Y) sub-blocks contains non-zero coefficients. In binary representation, the values “0” and “1” represent that the corresponding 8×8 sub-block has no coefficient and non-zero coefficients respectively. In chrominance (UV) sub-blocks, there are three possible CBP (called nc) ((1) no chrominance coefficients at all, (2) Only DC coefficients, (3) DC and AC coefficients). Table 2 shows the percentage of zero Y (MB_{N, Y̅}), non-zero Y (MB_{N,Y}), zero UV (MB_{N, U̅V̅}) and non-zero UV (MB_{N,UV}) macro-blocks in the non-skipped mode.

TABLE 2
Percentage of zero Y, non-zero Y, zero UV and non-zero UV
macro-blocks in the non-skipped mode.

| | |
|---|---|
| Video | Non-skipped MB (%) |

| Sequence | QP | MB_{N, Y̅} | MB_{N,Y} | MB_{N, U̅V̅} | MB_{N,UV} |
|---|---|---|---|---|---|
| Akiyo | 15 | 29.1 | 70.9 | 27.5 | 72.5 |
| | 35 | 13.5 | 86.5 | 87.6 | 12.4 |
| | 45 | 47.7 | 52.3 | 89.1 | 10.9 |
| Foreman | 15 | 0.9 | 99.1 | 6.8 | 93.2 |
| | 35 | 25.5 | 74.5 | 79.3 | 20.7 |
| | 45 | 56.7 | 40.3 | 81.4 | 18.6 |
| Stefan | 15 | 1.2 | 98.8 | 4.7 | 95.3 |
| | 35 | 12.9 | 87.1 | 38.5 | 61.5 |
| | 45 | 35.5 | 64.5 | 70.9 | 29.1 |

It is observed that the percentage of MB_{N, Y̅} and MB_{N, U̅V̅} increases with QP for any video sequences. In these macro-blocks, the Y/UV sub-blocks are skipped for quantization and encoding. Only the macro-block header is required for processing. It is also noticed that the percentages of MB_{N,Y} and MB_{N,UV} are higher in fast-motion “Stefan” sequence since the use of dominant MB_{N, Y̅} and MB_{N, U̅V̅} does not give a very reasonable video quality. From the above results, it is implied that each macro-block has different characteristics, including skipped and non-skipped macro-blocks. In the non-skipped macro-blocks, the number of Y and UV sub-blocks can change based on CBP parameters. Therefore, these advanced macro-block types should be taken into account in the herein described rate control scheme.

There is an interesting characteristic of the number of macro-block encoded bits between consecutive frames. It is found that the correlation of the number of encoded bits of macro-blocks between consecutive frames is high. In an empirical example Rᵢ and R′ᵢ were defined to be the number of encoded bits of the i-th macro-block in the previous and current frames respectively. The bit correlation is defined as the correlation coefficient:

$$\begin{matrix}{ρ}_{R , {R}^{′}} = \frac{E [ ( R - E [ R ] ) ( {R}^{′} - E [ {R}^{′} ] ) ]}{{σ}_{R} {σ}_{{R}^{′}}} \\ = \frac{\frac{1}{N} {\sum }_{j = 1}^{N} ( {R}_{j} - {\sum }_{i = 1}^{N} {R}_{i} / N ) ( {R}_{j}^{′} - {\sum }_{i = 1}^{N} {R}_{i}^{′} / N )}{\sqrt{\frac{1}{N} {\sum }_{j = 1}^{N} {( {R}_{j} - {\sum }_{i = 1}^{N} {R}_{i} / N )}^{2} \frac{1}{N} {\sum }_{j = 1}^{N} {( {R}_{j}^{′} - {\sum }_{i = 1}^{N} {R}_{i}^{′} / N )}^{2}}}\end{matrix} \qquad ( 1 )$$

where N is the number of macro-blocks in a frame.

TABLE 3
Bit correlation coefficient between consecutive frames with different
QP in different video sequences (before and after normalization).

QP

| Video | Normalization | 5 | 27 | 35 | 45 |
|---|---|---|---|---|---|
| Akiyo | Before | 0.975 | 0.876 | 0.868 | 0.983 |
| | After | 0.988 | 0.901 | 0.893 | 0.987 |
| Foreman | Before | 0.798 | 0.748 | 0.740 | 0.841 |
| | After | 0.833 | 0.783 | 0.781 | 0.880 |
| Mother | Before | 0.915 | 0.820 | 0.856 | 0.989 |
| | After | 0.944 | 0.877 | 0.891 | 0.991 |
| Silent | Before | 0.883 | 0.856 | 0.845 | 0.930 |
| | After | 0.922 | 0.881 | 0.887 | 0.955 |
| Stefan | Before | 0.927 | 0.877 | 0.828 | 0.791 |
| | After | 0.948 | 0.911 | 0.856 | 0.843 |

Table 3 shows bit correlation coefficient between consecutive frames with different QP in different video sequence in H.264. It is observed that the correlation is high (over nearly 0.8) at any QP in any one of video sequences (especially in “Akiyo” and “Mother”) before normalization, which will be discussed in the following section.

### Normalization

As described herein, there are various macro-block types in advanced coding standards, including skipped macro-blocks and non-skipped macro-blocks. In non-skipped macro-blocks, the number of Y and UV sub-blocks can change based on CBP parameters. A relatively high bit correlation between consecutive frames has been observed. It has been found that bit correlation between consecutive frames is even higher after the herein described normalization in consideration of macro-block types.

In H.264 Baseline Profile (see e.g., T. Wiegand, “Working Draft Number 2, Revision 8(WD-2 rev 8)”, JVT-B118r8, ISO/IEC MPEG & ITU-T-T VCEG, Geneva, Switzerland, 29 Jan.-29 Feb., 2002) a 4:2:0 sampling technique is normally adopted. Four Y-coefficients, one U-coefficient and one V-coefficient are sampled at a time. In the herein described normalization, each macro-block can be converted to the comparable non-skipped macro-block type with non-zero Y and non-zero UV coefficients by considering the Y/UV sampling ratio. The following shows the proposed estimated bits of the macro-block with various macro-block types.

MATRIX 1

| MB type | Estimated bits \hat{R} |
|---|---|
| MBₛ | R_{C,prev} + Rₚᵣₑᵥ |
| MB_{N,Y} ∩ MB_{N,UV} | R_{C} + R_{N,Y} × 4/n_{Y} + R_{N,UV} × 2/n_{UV} |
| MB_{N,Y} ∩ MB_{N, U̅V̅} | R_{C} + R_{N,Y} × 6/n_{Y} |
| MB_{N, Y̅} ∩ MB_{N,UV} | R_{C} + R_{N,UV} × 6/n_{UV} |
| MB_{N, Y̅} ∩ MB_{N, U̅V̅} | R_{C} + Rₚᵣₑᵥ |

where R_{C,prev} and Rₚᵣₑᵥ are the number of estimated bits of overhead data and residue data (i.e., Y and UV coefficients) of the co-located macro-block in the previous frame respectively. R_{C}, R_{N,Y} and R_{N,UV} are the number of encoded bits of overhead, Y coefficients and UV coefficients of the current macro-block respectively. n_{Y} and n_{UV} are the number of 8×8 non-zero Y coefficients and 4×4 non-zero UV coefficients in the current macro-block.

Regardless of Y or UV coefficients of a macro-block, the encoded bits of those coefficients mainly depend on their standard deviation of the macro-block. In other words, the encoded bits of Y coefficients are more or less similar to that of UV coefficients if their standard deviation is similar. When the macro-block belongs to the non-skipped macro-block with non-zero Y and non-zero UV coefficients, the estimated bits of the residue data of the macro-block is calculated as R_{C}+R_{N,Y}×4/n_{Y}+R_{N,UV}×2/n_{UV}. If the number of 8×8 non-zero Y coefficients and 4×4 non-zero UV coefficients is 4 and 2 respectively, the estimated bits are just copied from the encoded bits of Y and UV coefficients. In the case of the non-skipped macro-block with zero UV coefficient, the estimated bits of the residue data of the macro-block is calculated as R_{N,Y}×6/n_{Y}(=R_{N,Y}×(4+1+1)/4×4/n_{Y}). In the case of the non-skipped macro-block with zero Y coefficient, the estimated bits of the residue data of the macro-block is then calculated as R_{N,UV}×6/n_{UV}(=R_{N,UV}×(4+1+1)/2×2/n_{UV}). In the case of the non-skipped macro-block with zero Y and zero UV coefficients, the estimated bits of the residue data of the macro-block is copied from the estimated bits of co-located macro-block in the previous frame. In the case of the skipped macro-block, the estimated bits of the overhead and residue data of the macro-block are copied from estimated bits of overhead and residue data of the co-located macro-block in the previous frame.

Table 3 shows bit correlation coefficient between consecutive frames after normalization. It is observed that the bit correlation coefficient after normalization is higher than that before normalization at any QP in any one of video sequences as co-located macro-blocks in consecutive frames are more similar under the same macro-block-type condition after normalization. One can make use of this high bit correlation coefficient in the herein described rate control scheme.

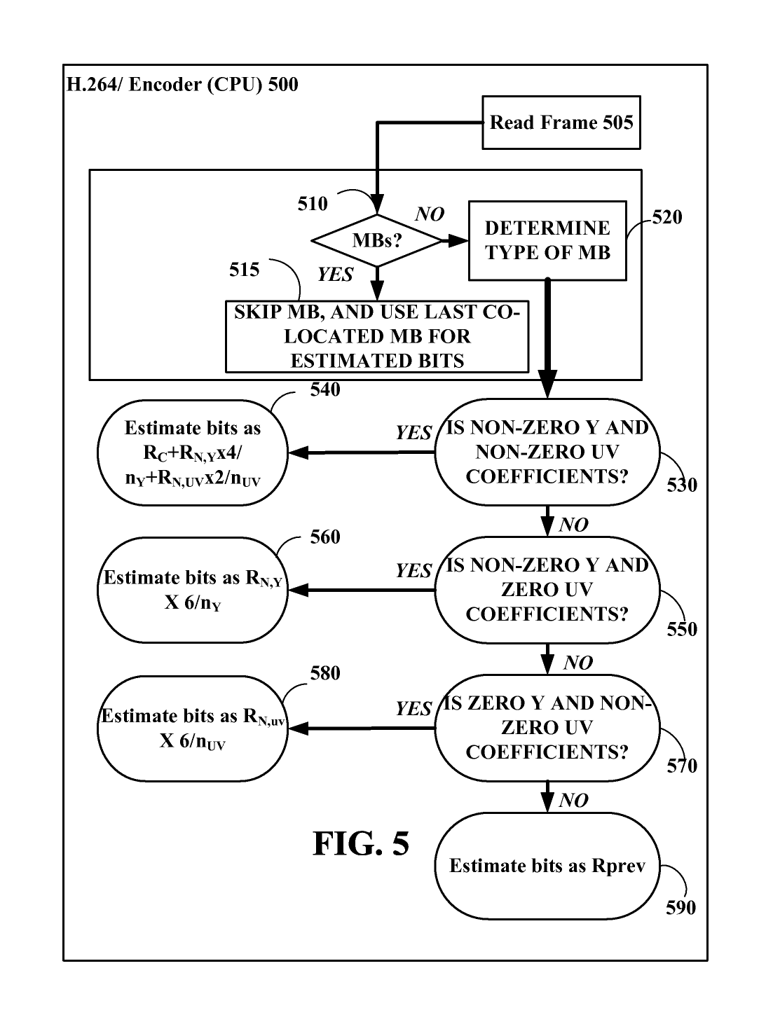

FIG. 5 illustrates the flow 500 an encoding CPU uses to determine or classify macro-blocks. A frame is read at 505. At 510, it is decided if it is a skipped macro-block (MBs). If yes, then at 515, the macro-block is skipped and the co-located MB from the last frame is used for the bit estimate. If it is not a skipped macro-block, then at 520 it is determined what type of MB the macro-block is. At 530, it is decided if the Y and UV are both non-zero. If so, then at 540 the estimate is R_{C}+R_{N,Y}×4/n_{Y}+R_{N,UV}×2/n_{UV}. If not, then at 550, it is decided if the Y is non-zero and the UV is zero. If yes, then at 560 the bit estimate is R_{N,Y}×6/n_{Y}. If no, then at 570 it is decided if the Y is zero and the UV is non-zero. If Yes, then at 580 the bit estimate is R_{N,UV}×6/n_{UV}. If no, then the estimate is R_{prev.} At the start of encoding each MB, a quantification parameter (QP) is used to encode the i-th MB. The normalized bits of the current i-th macro-block in the current frame and its co-located macro-block in the previous frame are based on the normalization described herein. When the accumulated estimated bits of the current frame is larger than that of the previous frame the quantization factor is increased 1. The QP is dynamically varied. In one embodiment, the employ of artificial intelligence (AI) component is done. The AI component can be employed to facilitate inferring and/or determining when, where, how to dynamically vary the QP. Such inference results in the construction of new events or actions from a set of observed events and/or stored event data, whether or not the events are correlated in close temporal proximity, and whether the events and data come from one or several event and data sources.

The AI component can also employ any of a variety of suitable AI-based schemes in connection with facilitating various aspects of the herein described innovation. For example, and in the context of a Structured Query Language (SQL) server/client where the client is a customer of the bank and the bank is using a server, a process for learning explicitly or implicitly how a value related to a parsed SQL statement should be replaced can be facilitated via an automatic classification system and process. Classification can employ a probabilistic and/or statistical-based analysis (e.g., factoring into the analysis utilities and costs) to prognose or infer an action that a user desires to be automatically performed.

For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

### Determination of Scene Change

It is known that scene change is likely to happen when the residue energy of the P-frame is relatively high (see e.g., X. Yang, W. Lin, Z. Lu, X. Lin, S. Rahardja, E. Ong and S. Yao, “Rate Control for Videophone Using Local Perceptual Cues”, IEEE Trans. Circuit Syst. Video Tech., vol. 15, pp.496-507, 2005 and H. J. Lee and T. H. Chiang and Y. Q. Zhang, “Scalable Rate Control for MPEG-4 Video”, IEEE Trans. Circuit Syst. Video Technol., vol. 10, pp. 878-894, 2000). This usually occurs in relatively fast-motion video and any video with a sudden change in static background. In Laplacian distribution x with probability function p(x), the residue energy Eᵢ of the i-th macro-block in the continuous case (see e.g., F. Moscheni, F. Dufaux and H. Nicolas, “Entropy criterion for optimal bit allocation between motion and prediction error information”, Proc. SPIE Visual Commun. And Image Proc., pp. 235-242, November 93) is given by

$$\begin{matrix}{E}_{i} = {\int }_{- ∞}^{∞} {x}^{2} p ( x ) d x - {( {\int }_{- ∞}^{∞} x p ( x ) d x )}^{2} \\ = {σ}_{i}^{2}\end{matrix} \qquad ( 2 )$$

The popular rate model Rᵢ of the i-th macro-block in TMN8 is given by

Rᵢ=Kσᵢ²/Qᵢ² (3)

where K, σᵢ and Qᵢ are model parameter, standard deviation and quantization step size of the i-th macro-block respectively.

By substituting Eq. (3) into Eq. (2), one can obtain

Eᵢ=RᵢQᵢ²/K (4)

For simplicity, one can use the following equation for determination of scene change as K is constant term and can be ignored if desired.

E′ᵢ=RᵢQᵢ² (5)

When the i-th macro-block is processed to be encoded, the accumulated residue energy E′ in the current frame is

$${E}^{′} = {\sum }_{j = 1}^{i} {R}_{j} {Q}_{j}^{2} \qquad ( 6 )$$

Scene change is determined when the following condition is held:

E′>Bₜ Q̅ₚᵣₑᵥ²×iL/N (7)

where Bₜ is the target total bits of the current frame, Q̅ₚᵣₑᵥ is the average QP of the previous frame, N is the total number of macro-block in the current frame and L is threshold factor for determination of scene change. In an empirical example, L is chosen to be 1.3. When the scene change happens, high bit correlation coefficient may not be held and the constant quantization step size is used instead for the remaining macro-blocks of the current frame.

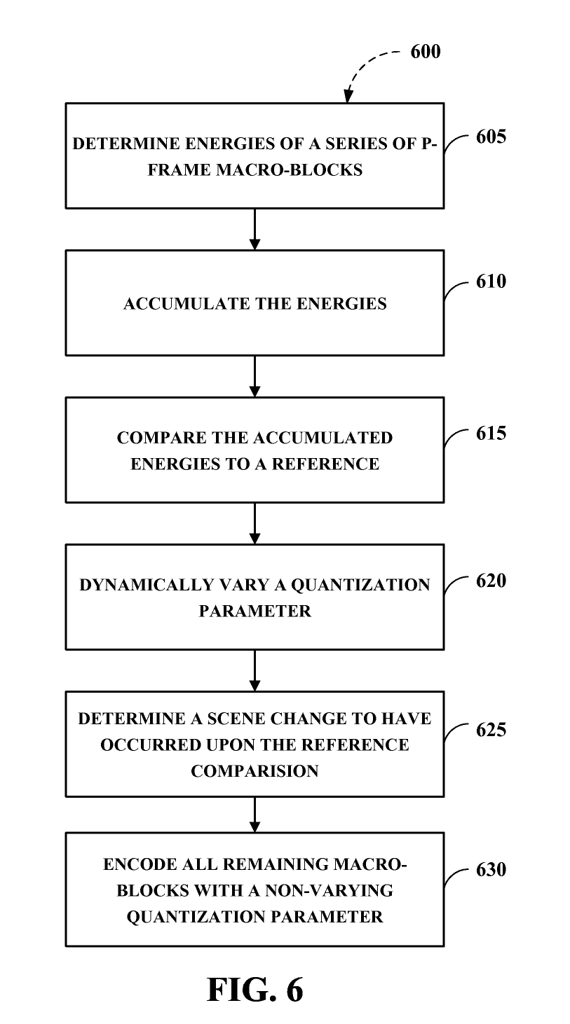

FIG. 6 is a flow diagram illustrating exemplary flow 600 to encode macro-blocks in accordance with optimizations for video encoding processes in accordance with the innovation. At 605, the energies are determined regarding the series of P-frame blocks. In other words, for each P-frame the energy is calculated as stated above. At 610, the energies are accumulated. At 615, the accumulated energies are compared to a reference such as Bₜ Q̅ₚᵣₑᵥ²×iL/N. At 620, the quantization parameter is dynamically varied. At 625, it is determined that a scene change has occurred because the accumulated energy is greater than the reference. Therefore as stated above and shown at 630 the remaining macro-blocks of that frame are encoded with a non-varying quantization parameter. For the next frame the quantization parameter is varied again.

The encoder buffer size W is updated before the current frame is encoded with the following formula:

W=max(Wₚᵣₑᵥ+B′−R_{ch}/F,0) (8)

where Wₚᵣₑᵥ is the previous number of bits in the buffer (initially set to zero), B′ is the actual number of bits used for the encoded previous frame, R_{ch} is the channel bit rate (bit per sec), and F is the frame rate (frame per sec).

After updating the buffer size, if W is larger than or equal to the predefined threshold M(=R/F), the encoder skips encoding the frames until W is smaller than M. This means that buffer overflow will not occur at the cost of frame skipping.

The target number of bits Bₜ for the current frame is estimated as:

$${B}_{t} = ( {R}_{ch} / F ) - Δ \\ where \\ Δ = \{ \begin{matrix}W / F & W > 0.1 M \\ W - 0.1 M , & otherwise\end{matrix} \qquad ( 9 )$$

The buffer size W keeps the low target buffer level (i.e. 0.1M) for real-time rate control with relatively low communication delay. For the first non-skipped P frame after the initial I frame, the fixed quantization parameter is used. This quantization parameter is chosen based on target bit rates by a look-up table. When target bit rates are higher, this QP is chosen to be smaller. At the start of the remaining P-frames, the following other parameters are required to be updated.

$$\{ \begin{matrix}w = {B}_{t} / {R}_{prev} \\ \hat{R} = 0 \\ {\hat{R}}^{′} = 0 \\ {E}^{′} = 0\end{matrix} \qquad ( 10 )$$

Where w, Rₚᵣₑᵥ, \hat{R}, \hat{R}′ and E′ are the weighting factor, the encoded bits of the previous frame, the accumulated estimated bits of the previous frame, the accumulated estimated bits of the current frame, and the accumulated residue energy of the current frame respectively. As Bₜ is not the same in consecutive frames, the parameter w is used to adjust the accumulated bits of the previous frame for comparison with that of the current frame.

### Macro-Block Layer Rate Control

The following shows the details of the macro-block layer rate control in accordance with one aspect of the innovation.

```
For each i-th MB {
      Use QPᵢ to encode the i-th MB
      Calculate Rᵢ and R′ᵢ for normalization
    \hat{R} = \hat{R} + w× \hat{R}ᵢ
    \hat{R}′ = \hat{R}′ +w× \hat{R}ᵢ′
    \hat{R}ᵢ = \hat{R}ᵢ′
      If ( \hat{R}′> \hat{R} ) {
          QPᵢ₊₁ = min{QPᵢ +1, 51, Q̅ₚᵣₑᵥ + T}
      }
      else {
          QPᵢ₊₁ = max{QPᵢ −1, 1, Q̅ₚᵣₑᵥ − T}
      }
      // accumulated energy of the current frame
      E′= E′+ \hat{R}ᵢ× Qᵢ²
      // check whether scene change occurs
      if (E′> Bₜ Q̅ₚᵣₑᵥ² ×iL/N and i > N_{T}) {
          break;
      }
}
```

At the start of encoding each MB, QPᵢ is used to encode the i-th MB. The normalized bits of the current i-th macro-block in the current frame \hat{R}_{i′} and its co-located macro-block in the previous frame \hat{R}ᵢ are based on the normalization described herein. When the accumulated estimated bits of the current frame is larger than that of the previous frame (i.e. \hat{R}′>\hat{R}), the quantization factor of the (i+1)-th MB QPᵢ₊₁ is increased by 1. It is observed that the value of QPᵢ₊₁ is bound by maximum QP factor (=51) and \hat{Q}ₚᵣₑᵥ+T where T is the QP threshold. The parameter T is used to avoid a large difference in spatial distortion between macro-blocks within the current frame in case high bit correlation is not held. In an empirical example, the value T is set to 3. In case the accumulated estimated bits of the current frame is smaller than that of the previous frame (i.e. \hat{R}′<\hat{R}), the quantization factor of the (i+1)-th MB QPᵢ₊₁ is decreased by 1 and bound by the minimum QP(=1) and Q̅ₚᵣₑᵥ−T. Then the accumulated energy of the current frame E′ is calculated based on Eq. (6). When Eq. (7) is valid after processing N_{T} MBs in the current frame (N_{T}=20 in the empirical example), scene change happens and the fixed quantization parameter is used for the remaining macro-blocks of the current frame regardless of any other \hat{R} and \hat{R}′. This encoding process will proceed for the next macro-block and the following macro-blocks in the current frame.

Performance of the innovation was implemented via a rate control scheme in a JVT JM 10.2 version. In the test, the first frame was intra-coded (I-frame) with QP=31 and several frames were skipped after the first frame to decrease the number of bits in the buffer below M=R/F. Then the remaining frames were all inter-coded (P-frames). This means that the number of skipped frames is the same in JM10.2 and the herein described methods and means. The herein described algorithms, and JM10.2 were simulated on some QCIF test sequences with a frame rate of 10 fps and various target bit rates. The test conditions were Motion Vector (MV) resolution at ¼ pel. Hadamard was “OFF”. RD optimization was “OFF”. Search range was “±16”. Restrict search range was “0”. Reference frames was “1” and symbol mode was “UVLC”.

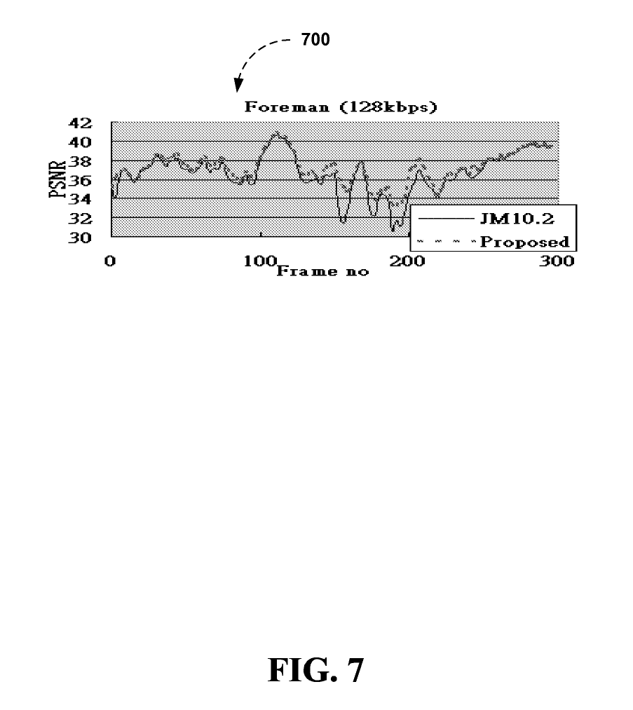

Table 4 shows the actual encoded bit rates achieved by JM10.2 and the proposed rate control. It is verified that these rate control methods can achieve the target bit rates. The error between target bit rate and actual bit rate is below 0.2%. Table 5 shows the comparison of PSNR of the reconstructed pictures for JM10.2 and the proposed rate control. A gain in PSNR by the proposed rate control over JM10.2 is observed, ranging from +0.10 dB to +0.31 dB. This is probably because the bit prediction is accurate based on the proposed normalization. FIG. 7 shows the comparison of PSNR against frame number in “Fmn128”. It is observed that the instantaneous PSNR is higher in herein disclosed algorithm at most of time.

TABLE 4
Comparison of bit rate achieved by JM10.2 and the proposed
rate control

| | | | |
|---|---|---|---|
| | | Target | Encoded bits |
| Test | Video | bit | (kbps) |

| Name | Sequence | (kbps) | JM 10.2 | Proposed |
|---|---|---|---|---|
| Aki24 | “Akiyo” | 24 | 24.05 | 24.01 |
| Fmn48 | “Foreman” | 48 | 48.07 | 48.04 |
| Fmn128 | “Foreman” | 128 | 128.14 | 128.13 |
| ctg256 | “Coast- | 256 | 255.63 | 254.64 |
| | guard” | | | |
| Sil24 | “Silent” | 24 | 24.04 | 24.02 |
| Stf256 | “Stefan” | 256 | 256.26 | 256.21 |

TABLE 5
Comparison of average PSNR for JM10.2 and the proposed rate control

| | | |
|---|---|---|
| Test | PSNR (dB) | PSNR Gain (dB) |

| Name | JM 10.2 | Proposed | over JM10.2 |
|---|---|---|---|
| Aki24 | 38.84 | 38.99 | +0.15 |
| Fmn48 | 32.01 | 32.22 | +0.21 |
| Fmn128 | 36.63 | 36.94 | +0.31 |
| ctg256 | 37.17 | 37.29 | +0.12 |
| Sil24 | 31.91 | 32.03 | +0.12 |
| Stf256 | 33.52 | 33.72 | +0.20 |

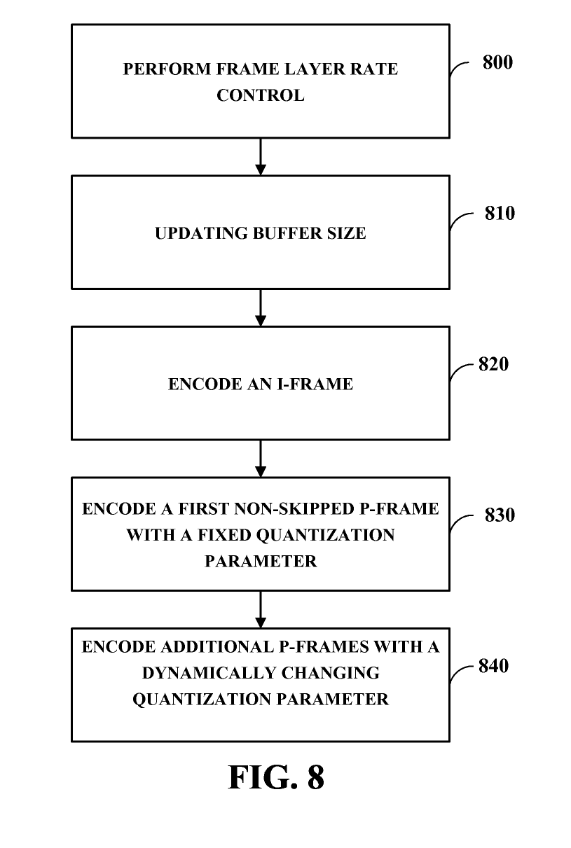

FIG. 8 is another flow diagram illustrating exemplary aspects of a process for performing optimized frame layer control for video encoding in accordance with the innovation. FIG. 8 illustrates at 800 the performance of a frame layer rate control. At 810, the buffer size is updated. At 820, an I-frame is encoded. At 830, a first non-skipped P-frame is encoded with an initial fixed quantization parameter. As explained better above, at 840 additional P-frames are encoded with a dynamically changing quantization parameter.

### Exemplary Computer Networks and Environments

One of ordinary skill in the art can appreciate that the innovation can be implemented in connection with any computer or other client or server device, which can be deployed as part of a computer network, or in a distributed computing environment, connected to any kind of data store. In this regard, the present innovation pertains to any computer system or environment having any number of memory or storage units, and any number of applications and processes occurring across any number of storage units or volumes, which may be used in connection with optimization algorithms and processes performed in accordance with the present innovation. The present innovation may apply to an environment with server computers and client computers deployed in a network environment or a distributed computing environment, having remote or local storage. The present innovation may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the optimization algorithms and processes of the innovation.

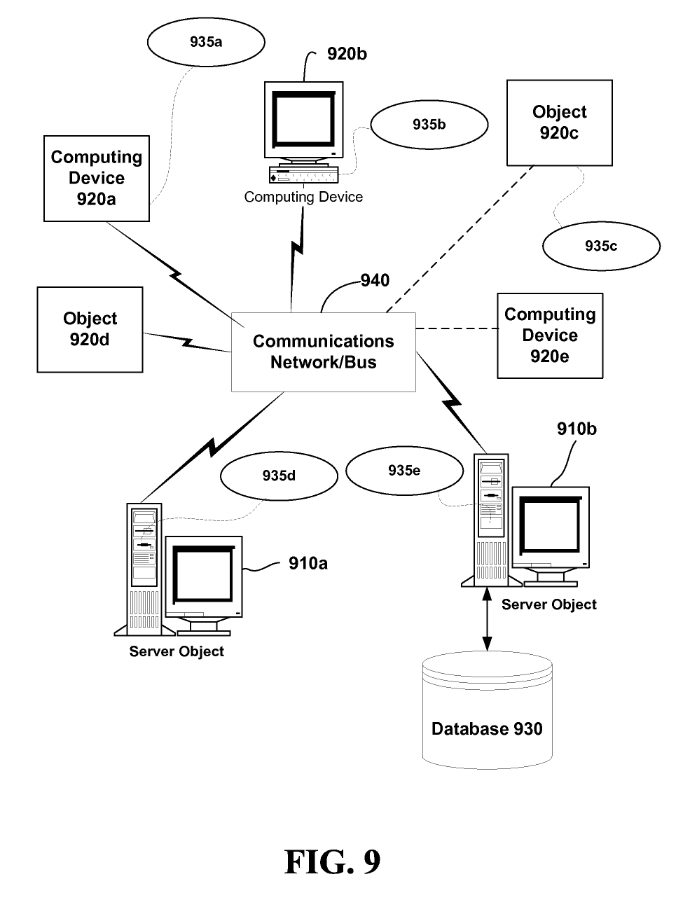

FIG. 9 provides a schematic diagram of an exemplary networked or distributed computing environment. The distributed computing environment comprises computing objects 910a, 910b, etc. and computing objects or devices 920a, 920b, 920c, 920d, 920e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 940. This network may itself comprise other computing objects and computing devices that provide services to the system of FIG. 9, and may itself represent multiple interconnected networks. In accordance with an aspect of the innovation, each object 910a, 910b, etc. or 920a, 920b, 920c, 920d, 920e, etc. may contain an application that might make use of an API, or other object, software, firmware and/or hardware, suitable for use with the design framework in accordance with the innovation.

It can also be appreciated that an object, such as 920c, may be hosted on another computing device 910a, 910b, etc. or 920a, 920b, 920c, 920d, 920e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to optimization algorithms and processes according to the present innovation.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11A/B/G) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present innovation may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 9, as an example, computers 920a, 920b, 920c, 920d, 920e, etc. can be thought of as clients and computers 910a, 910b, etc. can be thought of as servers where servers 910a, 910b, etc. maintain the data that is then replicated to client computers 920a, 920b, 920c, 920d, 920e, etc., although any computer can be considered a client, a server, or both, depending on the circumstances. Any of these computing devices may be processing data or requesting services or tasks that may implicate the optimization algorithms and processes in accordance with the innovation.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the optimization algorithms and processes of the innovation may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 9 illustrates an exemplary networked or distributed environment, with server(s) in communication with client computer (s) via a network/bus, in which the present innovation may be employed. In more detail, a number of servers 910a, 910b, etc. are interconnected via a communications network/bus 940, which may be a LAN, WAN, intranet, GSM network, the Internet, etc., with a number of client or remote computing devices 920a, 920b, 920c, 920d, 920e, etc., such as a portable computer, handheld computer, thin client, networked appliance, or other device, such as a VCR, TV, oven, light, heater and the like in accordance with the present innovation. It is thus contemplated that the present innovation may apply to any computing device in connection with which it is desirable to communicate data over a network.

In a network environment in which the communications network/bus 940 is the Internet, for example, the servers 910a, 910b, etc. can be Web servers with which the clients 920a, 920b, 920c, 920d, 920e, etc. communicate via any of a number of known protocols such as HTTP. Servers 910a, 910b, etc. may also serve as clients 920a, 920b, 920c, 920d, 920e, etc., as may be characteristic of a distributed computing environment.

As mentioned, communications may be wired or wireless, or a combination, where appropriate. Client devices 920a, 920b, 920c, 920d, 920e, etc. may or may not communicate via communications network/bus 14, and may have independent communications associated therewith. For example, in the case of a TV or VCR, there may or may not be a networked aspect to the control thereof. Each client computer 920a, 920b, 920c, 920d, 920e, etc. and server computer 910a, 910b, etc. may be equipped with various application program modules or objects 935a, 935b, 935c, etc. and with connections or access to various types of storage elements or objects, across which files or data streams may be stored or to which portion(s) of files or data streams may be downloaded, transmitted or migrated. Any one or more of computers 910a, 910b, 920a, 920b, 920c, 920d, 920e, etc. may be responsible for the maintenance and updating of a database 930 or other storage element, such as a database or memory 930 for storing data processed or saved according to the innovation. Thus, the present innovation can be utilized in a computer network environment having client computers 920a, 920b, 920c, 920d, 920e, etc. that can access and interact with a computer network/bus 940 and server computers 910a, 910b, etc. that may interact with client computers 920a, 920b, 920c, 920d, 920e, etc. and other like devices, and databases 930.

### Exemplary Computing Device

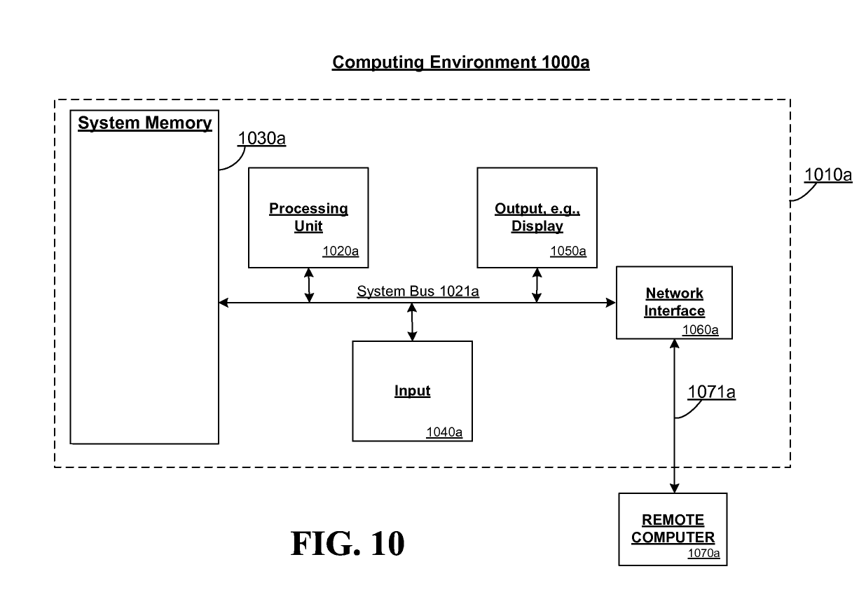

As mentioned, the innovation applies to any device wherein it may be desirable to communicate data, e.g., to a mobile device. It should be understood, therefore, that handheld, portable and other computing devices and computing objects of all kinds are contemplated for use in connection with the present innovation, i.e., anywhere that a device may communicate data or otherwise receive, process or store data. Accordingly, the below general purpose remote computer described below in FIG. 10 is but one example, and the present innovation may be implemented with any client having network/bus interoperability and interaction. Thus, the present innovation may be implemented in an environment of networked hosted services in which very little or minimal client resources are implicated, e.g., a networked environment in which the client device serves merely as an interface to the network/bus, such as an object placed in an appliance.

Although not required, the innovation can partly be implemented via an operating system, for use by a developer of services for a device or object, and/or included within application software that operates in connection with the component(s) of the innovation. Software may be described in the general context of computer executable instructions, such as program modules, being executed by one or more computers, such as client workstations, servers or other devices. Those skilled in the art will appreciate that the innovation may be practiced with other computer system configurations and protocols.

FIG. 10 thus illustrates an example of a suitable computing system environment 1000a in which the innovation may be implemented, although as made clear above, the computing system environment 1000a is only one example of a suitable computing environment for a media device and is not intended to suggest any limitation as to the scope of use or functionality of the innovation. Neither should the computing environment 1000a be interpreted as having any dependency or requirement relating to any one or combination of components illustrated in the exemplary operating environment 1000a.

With reference to FIG. 10, an exemplary remote device for implementing the innovation includes a general purpose computing device in the form of a computer 1010a. Components of computer 1010a may include, but are not limited to, a processing unit 1020a, a system memory 1030a, and a system bus 1021a that couples various system components including the system memory to the processing unit 1020a. The system bus 1021a may be any of several types of bus structures including a memory bus or memory controller, a peripheral bus, and a local bus using any of a variety of bus architectures.

Computer 1010a typically includes a variety of computer readable media. Computer readable media can be any available media that can be accessed by computer 1010a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1010a. Communication media typically embodies computer readable instructions, data structures, program modules or other data in a modulated data signal such as a carrier wave or other transport mechanism and includes any information delivery media.

The system memory 1030a may include computer storage media in the form of volatile and/or nonvolatile memory such as read only memory (ROM) and/or random access memory (RAM). A basic input/output system (BIOS), containing the basic routines that help to transfer information between elements within computer 1010a, such as during start-up, may be stored in memory 1030a. Memory 1030a typically also contains data and/or program modules that are immediately accessible to and/or presently being operated on by processing unit 1020a. By way of example, and not limitation, memory 1030a may also include an operating system, application programs, other program modules, and program data.

The computer 1010a may also include other removable/non-removable, volatile/nonvolatile computer storage media. For example, computer 1010a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1021a through a non-removable memory interface such as an interface, and a magnetic disk drive or optical disk drive is typically connected to the system bus 1021a by a removable memory interface, such as an interface.

A user may enter commands and information into the computer 1010a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1020a through user input 1040a and associated interface(s) that are coupled to the system bus 1021a, but may be connected by other interface and bus structures, such as a parallel port, game port or a universal serial bus (USB). A graphics subsystem may also be connected to the system bus 1021a. A monitor or other type of display device is also connected to the system bus 1021a via an interface, such as output interface 1050a, which may in turn communicate with video memory. In addition to a monitor, computers may also include other peripheral output devices such as speakers and a printer, which may be connected through output interface 1050a.

The computer 1010a may operate in a networked or distributed environment using logical connections to one or more other remote computers, such as remote computer 1070a, which may in turn have media capabilities different from device 1010a. The remote computer 1070a may be a personal computer, a server, a router, a network PC, a peer device or other common network node, or any other remote media consumption or transmission device, and may include any or all of the elements described above relative to the computer 1010a. The logical connections depicted in FIG. 10 include a network 1071a, such local area network (LAN) or a wide area network (WAN), but may also include other networks/buses. Such networking environments are commonplace in homes, offices, enterprise-wide computer networks, intranets and the Internet.

When used in a LAN networking environment, the computer 1010a is connected to the LAN 1071a through a network interface or adapter. When used in a WAN networking environment, the computer 1010a typically includes a communications component, such as a modem, or other means for establishing communications over the WAN, such as the Internet. A communications component, such as a modem, which may be internal or external, may be connected to the system bus 1021a via the user input interface of input 1040a, or other appropriate mechanism. In a networked environment, program modules depicted relative to the computer 1010a, or portions thereof, may be stored in a remote memory storage device. It will be appreciated that the network connections shown and described are exemplary and other means of establishing a communications link between the computers may be used.

While the present innovation has been described in connection with the preferred embodiments of the various Figures, it is to be understood that other similar embodiments may be used or modifications and additions may be made to the described embodiment for performing the same function of the present innovation without deviating therefrom. For example, one skilled in the art will recognize that the present innovation as described in the present application may apply to any environment, whether wired or wireless, and may be applied to any number of such devices connected via a communications network and interacting across the network. Therefore, the present innovation should not be limited to any single embodiment, but rather should be construed in breadth and scope in accordance with the appended claims.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Various implementations of the innovation described herein may have aspects that are wholly in hardware, partly in hardware and partly in software, as well as in software. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present innovation, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the innovation. In the case of program code execution on programmable computers, the computing device generally includes a processor, a storage medium readable by the processor (including volatile and non-volatile memory and/or storage elements), at least one input device, and at least one output device.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture”, “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the various flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present innovation has been described in connection with the preferred embodiments of the various figures, it is to be understood that other similar embodiments may be used or modifications and additions may be made to the described embodiment for performing the same function of the present innovation without deviating therefrom.

While exemplary embodiments refer to utilizing the present innovation in the context of particular programming language constructs, specifications or standards, the innovation is not so limited, but rather may be implemented in any language to perform the optimization algorithms and processes. Still further, the present innovation may be implemented in or across a plurality of processing chips or devices, and storage may similarly be effected across a plurality of devices. Therefore, the present innovation should not be limited to any single embodiment, but rather should be construed in breadth and scope in accordance with the appended claims.

What is claimed is:

1. A method for encoding video data including a sequence of image frames in a computing system, comprising:
receiving at least one reference frame of the sequence of image frames;
identifying a set of macro-blocks within a current frame of the sequence to be encoded;
normalizing the macro-blocks based on a Y/UV sampling ratio where U and V provide color information and Y refers to luminance; and
storing the normalized macro-blocks in a computer readable storage medium.

2. The method of claim 1, further including:
estimating bits based on the U, V, and Y.

3. The method of claim 3, further including:
estimating bits based on the U, V, and Y such that a non-skipped macro-block with a zero Y and a zero UV coefficients is assigned data from a co-located macro-block from a previous frame.

4. The method of claim 3, further including:
estimating bits based on the U, V, and Y such that with respect to a skipped macro-block, the estimated bits of overhead and residue data of the skipped macro-block are copied from estimated bits of overhead and residue data from a co-located macro-block from a previous frame.

5. The method of claim 1, further including:
estimating bits using data regarding a co-located macro-block from a previous frame.

6. The method of claim 1, further comprising:
determining an energy of at least one macro-block.

7. The method of claim 6, further comprising:
accumulating energies of a plurality of macro-blocks.

8. The method of claim 7, further comprising:
comparing the accumulation of energies to a reference and encoding all remaining macro-blocks with a non-varying quantization parameter when the accumulation is greater than the reference.

9. A computer readable medium comprising computer executable instructions for performing the method of claim 1.

10. The method of claim 1, further comprising:
dynamically varying a quantization parameter used to encode the normalized macro-blocks.

11. The method of claim 10, further comprising:
accumulating energies of a plurality of macro-blocks.

12. The method of claim 11, further comprising:
comparing the accumulation of energies to a reference and encoding all remaining macro-blocks with a non-varying quantization parameter when the accumulation is greater than the reference.

13. Graphics processing apparatus comprising means for performing the method of claim 1.

14. A video compression system for compressing video in a computing system, comprising:
at least one data store for storing a plurality of frames of video data; and
a host system that processes at least part of an encoding process for the plurality of frames and transmits to a graphics subsystem a reference frame of the plurality of frames and a plurality of P-frames that include a plurality of macro-blocks; wherein the host system performs the encoding process for the macro-blocks while dynamically varying a quantization parameter used to encode the macro-blocks.

15. The system of claim 14, wherein the host system accumulate energies of a plurality of macro-blocks and compares the accumulation a reference and encodes all remaining macro-blocks with a non-varying quantization parameter when the accumulation is greater than the reference.

16. The system of claim 14, wherein the host system estimates bits using data regarding a co-located macro-block in a previous frame.

17. The system of claim 14, wherein the host system normalizes the macro-blocks based on a sampling ratio.

18. The system of claim 17, wherein the sampling ratio is a Y/UV sampling ratio where U and V provide color information and Y refers to luminance.

19. The system of claim 14, wherein the host system normalizes the macro-blocks and calculates an energy of each normalized macro-block.

20. A video encoding system for encoding video in a computing environment, comprising:
means for accessing at least one reference frame of a sequence of image frames;
means for accessing a set of macro-blocks within a P-frame of the sequence to be encoded; and
means for normalizing the macro-blocks based on a Y/UV sampling ratio where U and V provide color information and Y refers to luminance.
